(19) United States
(12) Patent Application Publication
(10) Pub. No.: US 2006/0156616 A1
(43) Pub. Date: Jul. 20, 2006

(54) Apparatus and method for removal of birds from buildings

(76) Inventor: William P. Ried, Paola, KS (US)

Correspondence Address: MCKEE, VOORHEES & SEASE, P.L.C., 801 GRAND AVENUE, SUITE 3200, DES MOINES, IA, 50309-2721, US

(21) Appl. No.: 11/036,562

(22) Filed: Jan. 14, 2005

(51) Int. Cl. A01M 23/08

(52) U.S. Cl. 43/65; 43/66

(57) ABSTRACT

The current invention is a bird trapping device comprising a means for luring birds toward a hollow and substantially vertical shaft. The shaft is configured with a substantially closed top which prevents birds from exiting the top. The shaft is further configured with a means for allowing visibility through a second side of the shaft opposite an opening in a first side of the shaft. The shaft is further configured so that a bird cannot maintain forward flight in the shaft and falls through the shaft into a holding pen assembly.

### BACKGROUND OF THE INVENTION

This invention relates to an apparatus and method for removal of birds from buildings.

Birds enter structures such as retail stores, warehouses, manufacturing facilities, and other high ceiling environments. It is commonly known that birds carry many diseases. They pose direct health risks to employees and customers and present a risk of contamination to food in such environments. Birds enter such environments via shopping cart doors, loading docks, human entrances, and other openings in the structures. Birds enter commercial structures in hot, cold, or rainy weather to optimize their comfort and are teaching other birds methods of ingress in the buildings. Seasonal migration can compound the problem.

In many situations, birds have become smart and successfully avoid being trapped by existing trapping technologies to remove the birds from the environments. To make matters worse, the birds which avoid being trapped have also developed methods of absconding with the associated bait which is being used. As a result, birds have developed a resistance to being trapped by observing other birds trapped and by being trapped themselves and then released. Thus, it is desirable to create a bird trapping device for removing birds from buildings which reduces teaching other birds how to avoid being trapped and removed from buildings.

The primary objective of the present invention is to provide an improved apparatus and method for removal of birds from buildings.

A further objective of the present invention is to provide an apparatus which removes birds from within buildings in addition to removing birds from rooftops.

A further objective of the present invention is to provide a device for trapping birds which allows birds to use and explore the device without being trapped in order to train the birds not to fear the device.

A further objective of the present invention is to provide a device for sustaining trapped birds until they can be removed.

A further objective of the present invention is to provide a device which allows the current invention to be serviced from the ground.

A further objective of the present invention is to provide a food dispensing apparatus in which multiple food sources can be used in a single feeder.

A further objective of the present invention is to provide a bird trapping device which does not allow untrapped birds to view the trapped birds, thereby not teaching the untrapped birds to fear the device.

A further objective of the present invention is the provision of the apparatus for removal of birds from buildings which is economical to manufacture, durable in use, and efficient in operation.

A further objective of the present invention is to provide a method of removing birds from buildings.

A further objective of the present invention is to reduce opportunites for birds to transmit diseases by removing the birds from buildings and away from the people and products in the building.

One or more of these or other objects of the invention will be apparent from the specification and claims that follow.

### SUMMARY OF THE INVENTION

The foregoing objects may be achieved by a bird trapping device comprising a means for luring birds toward a substantially vertical shaft. The shaft is defined by one or more panels or screens which are connected together or shaped so as to form a hollow tube. The shaft is further configured with a substantially closed top which prevents birds from exiting the top. The shaft is further configured with a means for allowing visibility through a second side of the shaft opposite the opening in the first side of the shaft. The shaft is still further configured so that a bird cannot maintain forward flight in the shaft. The shaft is still further configured with an upper portion and a lower portion. The upper portion is configured with an opening in the upper portion for allowing birds to pass through a first side in the shaft and enter the shaft. The lower portion of the shaft is configured so as to prevent a bird which falls from the upper portion through the shaft to the lower portion of the shaft from exiting the lower portion of the shaft vertically through the shaft toward the upper portion of the shaft.

A further feature of the present invention involves a bird trapping device wherein a bird feeder is positioned outside of the shaft so as to be visible through an opening in the upper portion of the shaft through the second side of the shaft opposite the opening from the first side of the shaft.

A further feature of the present invention is a bird trapping device wherein a shaft is configured so as to allow sound to pass through the shaft and through an opening in the first side of the shaft so that a bird located opposite the second side of the shaft can hear sounds from outside of the second side of the shaft.

A further feature of the present invention is a bird trapping device wherein a means for allowing visibility through a second side of a shaft is a transparent panel configured with one or more openings in the panel, so as to allow sound to pass through the opening, but not allow birds to pass through the opening.

A further feature of the present invention is a bird trapping device wherein a shaft is configured with one or more flaps which allow a bird to travel downward through the shaft from an upper portion to the lower portion but prevent a bird from traveling upward from the lower portion of the shaft to an upper portion.

A further feature of the present invention involves a bird trapping device wherein a lower portion of a shaft is affixed to a holding pen, wherein the holding pin is configured to sustain trapped birds.

A further feature of the present invention involves a bird trapping device wherein a luring means is a bait station located outside of the second side of a shaft wherein the bait station is visible through an opening in the first side of the shaft.

A further feature of the present invention involves a bird trapping device wherein a luring means is a bait station located through a top side of a funneling device wherein the bait station dispenses bait inside the funneling device.

A further feature of the present invention involves a bird trapping device wherein an upper portion of a shaft is configured with a funneling device directed toward and encloseably connected around an opening in the upper portion of the shaft.

A further feature of the present invention involves a bird trapping device wherein the device is configured with a funneling device which mounts through an opening in an exterior wall of the building so that a shaft extends downward on the exterior of the building.

A further feature of the present invention involves a bird trapping device wherein the device is configured for a funneling device to mount on a building roof, near an edge of the roof, with a shaft extending downward therefrom along the side of the building.

A further feature of the present invention involves a bird trapping device wherein the device is configured with both a funneling device configured to mount through an opening on an exterior wall of a building and a funneling device to mount on building roof near an edge of the roof, with the shaft extending downward therefrom along the side of the building and connecting with both funnels.

A further feature of the present invention involves a bird trapping device wherein a funneling device comprises a top, a bottom and a side. The side is configured to attach to both the top and the bottom. The side is further configured in a rounded shape so as to direct birds within the funnel which face the outer edge of the side toward the opening in an upward portion of the shaft.

A further feature of the present invention involves a bird trapping device comprising a removable funnel insert. The insert is configured with a first arch and a second arch which extend upward from a bottom. The first arch is larger than the second arch and is completed to mate with an opening in the side of the funneling device. The second arch is configured to attach to the first arch inward of the side of the funneling device. The insert is further configured with a mesh connecting the first arch to the second arch. The insert is further configured so that the bottom of the arches are open to the bottom of the funneling device.

A further feature of the present invention involves a bird trapping device wherein a funneling device is configured with two sides, a top, a bottom and an angle wall. The top, bottom and two sides are configured to mate together and to an opening in a shaft. The angle wall is configured to affix inside of the top, bottom and two sides wherein a top portion of the angle wall mounts angularly from a front side of the top toward a back side of the bottom leaving a gap between the angle wall and the bottom.

A further feature of the present invention involves a bird trapping device wherein a funneling device is configured as a panel which mates to an opening in an upper portion of a shaft. The panel is configured with one or more holes through the panel. The panel is further configured with landing pins affixed to the panel below the one or more holes and protruding away from the shaft. The panel is still further configured with non-exit pins affixed to the panel around one or more of the one or more holes extending towards the shaft.

The foregoing objects may also be achieved by a food dispensing apparatus comprising a first vertical transparent tube, a removable cover comprising an opening in a top of the first tube. The first tube is configured with one or more landing shafts extending radially outward from the bottom of the first tube. A mesh basket is affixed to the bottom of the first tube wherein the first tube is open on the bottom for allowing a first dispensed food to fall into the basket and a second vertical tube located concentrically inside of the first tube for dispensing a second food. The second tube is configured with holes in the tube for allowing the second food to mix with the first food for dispensing.

The foregoing objects may also be achieved by a method of removing birds from a building comprising the steps of luring birds into a substantially vertical shaft, allowing the birds to enter an opening in one side of an upper portion of the shaft, preventing the birds from maintaining flight once in the shaft, which in turn causes the birds to fall to a lower portion of the shaft, and preventing the birds from exiting the lower portion of the shaft through the upper portion of the shaft once the bird has entered the lower portion of the shaft.

A further feature of the present invention involves a method of removing birds from a building comprising a step of funneling birds which are to be removed from the building toward an opening end of an upper portion of a shaft.

A further feature of the present invention involves a method of removing birds from a building comprising the step of training the birds to not fear a vertical shaft by bating the birds to the vertical shaft by allowing the birds for a time to enter and exit the shaft without being trapped.

The term bird feeder in this application can refer to any device that provides food or water to birds.

### BRIEF DESCRIPTION OF THE FIGURES AND DRAWINGS

FIG. 1 is a three dimensional drawing showing one embodiment of a bird trapping assembly of the current invention.

FIG. 2 is a front view of one embodiment of the bird trapping assembly.

FIG. 3 is one embodiment of a side view of the bird trapping assembly.

FIG. 4 is a top view of one embodiment of the bird trapping assembly.

FIG. 5 is a side view of one embodiment of a rooftop funnel assembly.

FIG. 6 is a top view of one embodiment of a rooftop funnel assembly.

FIG. 7 is one embodiment of an inset feeder assembly.

FIG. 7A is an enlarged view of the bottom portion of an inset feeder assembly.

FIG. 8 is a side view of a removeable funnel assembly.

FIG. 9 is a front view of a removeable funnel assembly.

FIG. 10 is one embodiment of a conversion plate.

FIG. 11 is a front view of one embodiment of a through wall funnel assembly.

FIG. 12 is a side view of one embodiment of a through wall funnel assembly.

FIG. 13 is a front view of an alternate through wall funnel assembly.

FIG. 14 is a side view of an alternate through wall funnel assembly.

FIG. 15 is a three dimensional view of a still further alternate funnel assembly.

FIG. 16 is a front view of an alternate window assembly.

FIG. 17 is a side view of an alternate window assembly.

FIG. 18 is a drawing showing one embodiment of an alternate hanging feeder assembly.

FIG. 18A is an enlarged view of a bottom portion of the alternate hanging feeder assembly.

FIG. 19 is a front view of one embodiment of a holding pen assembly.

FIG. 20 is a top view of one embodiment of a holding pen assembly.

FIG. 21 is a sectional view of one embodiment of a holding pen assembly.

FIG. 22 is another sectional view of one embodiment of the holding pen assembly.

FIG. 23 is one embodiment of an extractor assembly mating with one embodiment of the holding pen assembly.

FIG. 24 is one embodiment of a heated waterer for use with the holding pen assembly.

### DETAILED DESCRIPTION OF THE PREFERRED EMBODIMENT

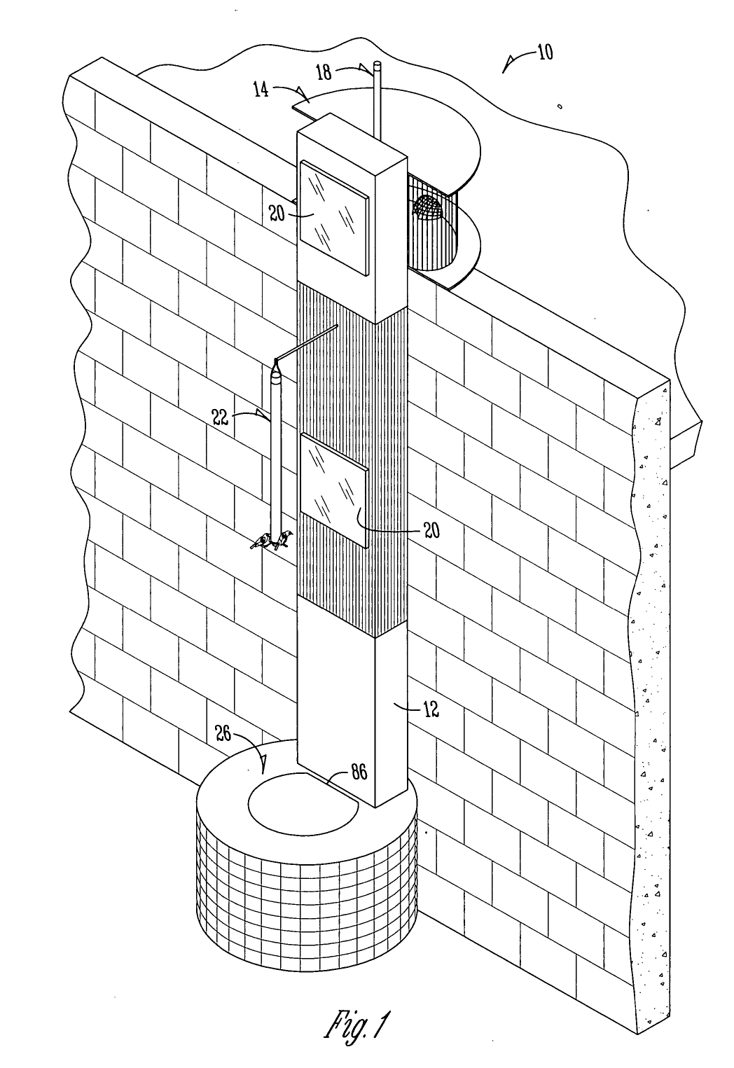

FIG. 1 shows one embodiment of the current invention. This invention utilizes the fact that birds are attracted to food, water, daylight, and sight and sound of other birds. The way the bird trapping assembly 10 works is that birds are lured towards a funneling device such as the rooftop funnel assembly 14. Once the bird enters the rooftop funnel assembly 14 the bird cannot find its way back out of the funnel assembly 14. However, the funnel assembly 14 is attached to the shaft 12 and an opening 30 in the shaft 12 allows a bird which is in the funnel assembly 14 to enter the shaft 12.

The shaft 12 is preferred to be constructed from one or more sheets of ribbed lexan material connected together or formed so as to form a hollow tube for the shaft 12. However, any rigid material can work to create the shaft 12. A bird in the rooftop funnel assembly 14 sees the window 20. The window 20 is a transparent glass or plastic type material. Thus, the bird trapped in the funnel assembly 14 thinks that the window 20 is an escape or exit from the funnel assembly 14. As a result, the bird tries to fly through the shaft 12 and out the window 20. It is preferred that the shaft 12 be constructed approximately 8 to 12 inches deep. A bird which enters the shaft 12 will not be able to maintain forward flight in the shaft 12 and will thus fall through the shaft 12 into the holding pen assembly 26. Other birds observing this, will believe that the bird in the shaft 12 has escaped and will thus not be afraid of the rooftop funnel assembly 14.

A through wall funnel assembly 16 (not shown in this view) may also be incorporated into the bird trapping assembly 10. The through wall funnel assembly 16 works similar to the rooftop funnel assembly 14 for the fact that the bird is lured towards the funnel assembly 16 and tries to escape the funnel assembly through the window 20 in the shaft 12. When the bird cannot fly through the window 20 it falls to the holding pen assembly 26. A difference between the rooftop funnel assembly 14 and the through wall funnel assembly 16 is that it is preferred a rooftop funnel assembly 14 has an inset feeder assembly 18 which is basically a tube filled with grain or other type of bird food for attracting the bird into the funnel assembly from the roof of the building. A hanging feeder assembly 22 is preferred to be hanging outside of the window 20 for the through wall funnel assembly 16. It is preferred that the feeder 22 be attached to a pulley or similar device so that it can be lowered and serviced from the ground. The through wall funnel assembly 16 mounts through an opening or a window in an existing wall of a building. The bird inside the building then tries to exit the building or tries to feed from the hanging feeder assembly 22 but cannot exit through the window 20 and falls to the holding pen assembly 26.

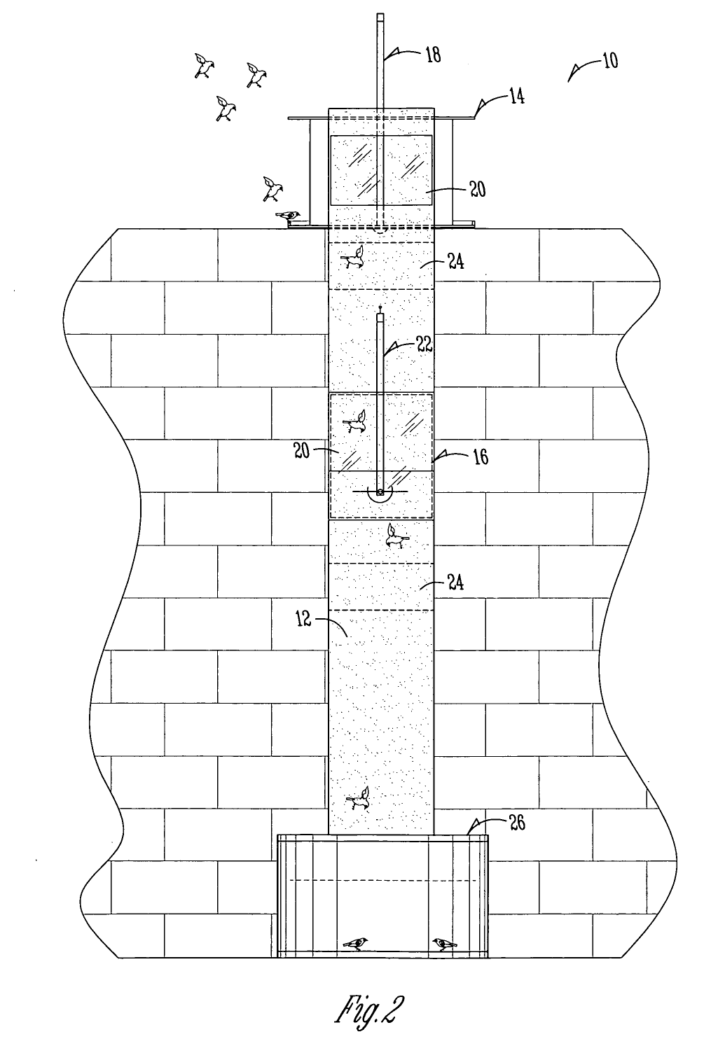

FIG. 2 shows a view of this embodiment of the bird trapping assembly 10 from outside a building looking directly at the assembly 10. FIG. 2 also shows the one-directional flaps 24. These flaps 24 are preferred to be made of a flexible plastic type material. The flaps 24 are also preferred to be connected to the walls of the shaft 12 so that a bird can travel downward through the flaps 24 yet cannot fly upward through the flaps 24. Thus, once a bird passes through the flaps 24, the bird cannot fly upward through the shaft 12 past the flaps 24.

FIG. 3 shows a side view of one embodiment of the bird trapping assembly 10. This view shows the shaft 12 mounted flush with an existing wall of a building. The rooftop funnel assembly 14 is shown attached to the shaft 12 sitting atop of the roof of an existing building. The through wall funnel assembly 16 is shown attaching to the shaft 12 and extending through an opening or window in an existing wall of a building.

FIG. 3 also shows one embodiment of a removeable funnel assembly 32 inserted in the rooftop funnel assembly 14. The purpose of a removeable funnel assembly 32 is so that a bird which enters the rooftop funnel assembly 14 through the removeable funnel assembly 32 has to duck down a little to enter through the removeable funnel assembly 32. A bird is willing to do this when going towards a food source such as the inset feeder assembly 18. However, once inside the rooftop funnel assembly 14, the bird does not realize that the bird has to duck to get out of the rooftop funnel assembly 14 through the removeable funnel assembly 32. Thus, the bird in the rooftop funnel assembly 14 cannot find its way back out of the rooftop funnel assembly 14. Therefore, the only perceived exit for the bird is through the window 20 in the shaft 12. However, the bird cannot exit through the window 20 and will fall through the shaft 12 to the holding pen assembly 26. This gives the appearance to other birds that the first bird has escaped. Therefore, other birds will not fear the bird trapping assembly 10.

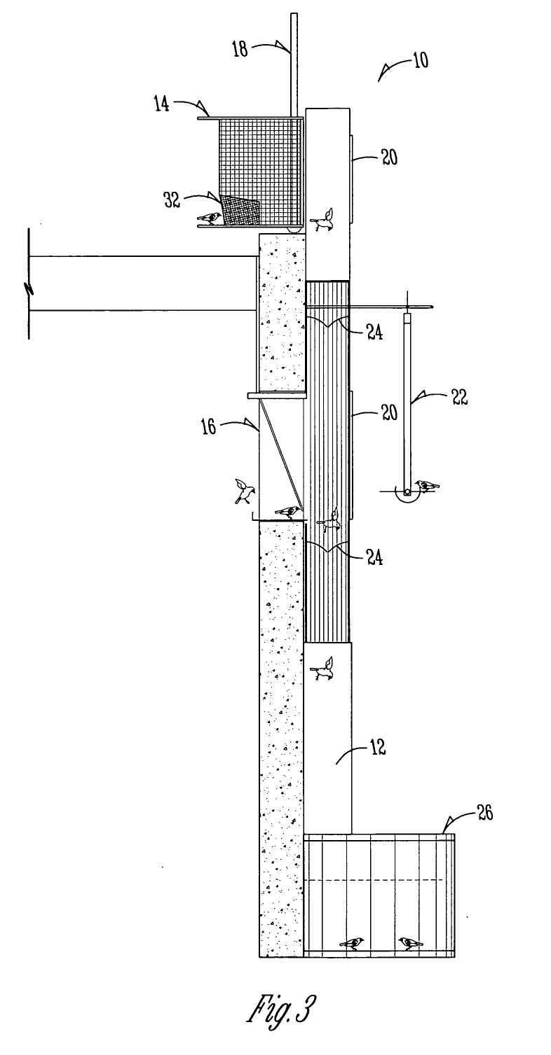

FIG. 4 shows a top view of this embodiment of the bird trapping assembly 10. It is preferred that the shaft 12 have a removeable top (not shown) over the shaft. In this way, a bird cannot fly upward through the shaft to escape the bird trapping assembly 10.

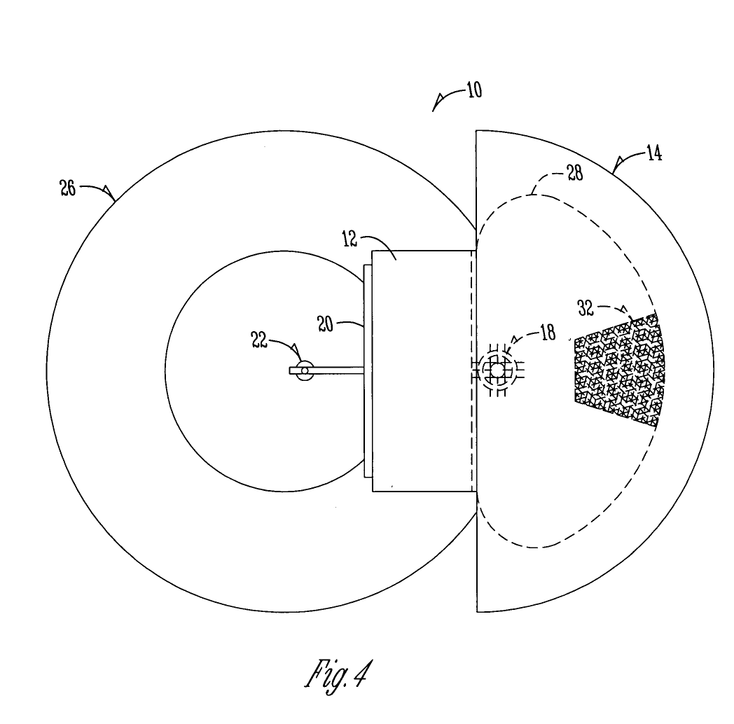

FIGS. 5 and 6 respectively shown an enlarged view of the side and the top of one embodiment of the rooftop funnel assembly 14. The funnel assembly 14 rests on either a ledge or directly on the rooftop of an existing building. This embodiment is constructed with a rooftop funnel assembly top 120 and a rooftop funnel assembly bottom 122 with a screen 28 in between the top 120 and the bottom 122. It is preferred that the screen 28 be a wire screen with openings small enough to prevent birds from traveling through the openings in the screen 28. However, any solid or perforated wall material can be used.

It is preferred that the screen 28 be shaped between the top 120 and the bottom 122 so that as a bird inside of the rooftop funnel assembly 14 which travels within the funnel assembly 14 along the outer edge of the screen 28 will always be directed toward the opening in the shaft 30. This helps the bird to find the opening in the shaft 30. The top 120 and the bottom 122 both provide a landing surface for a bird to land on. A bird can land on the bottom surface 122 and then walk into the inside of the rooftop funnel assembly 14 through the removeable funnel assembly 32.

Having a removeable funnel assembly 32 allows the user to take the funnel assembly 32 out of the rooftop funnel assembly 14 thereby allowing birds to travel freely in and out of the rooftop funnel assembly 14 and therefore, learn to not fear the funnel assembly 14. Once birds have become comfortable entering the rooftop funnel assembly 14 for food, which is dispensed by the inset feeder assembly 18 the user can then install the removeable funnel assembly 32. As explained above, a bird must generally duck to enter through the removeable funnel assembly 32 to get to the food source of the inset feeder assembly 18. However, once inside the rooftop funnel assembly 14, a bird does not know to duck to get back out through the removeable funnel assembly. Thus, the bird is trapped within the removeable funnel assembly 14.

Because the bird which is inside the rooftop funnel assembly 14 cannot find a way out it believes the only method of escape is through the opening in the shaft 30 and out the window 20. However, because the window 20 is not open to allow a bird to pass through it, the bird enters the shaft 12 and cannot maintain flight in the shaft 12 and falls through the one directional flaps 24 to the holding pen assembly 26.

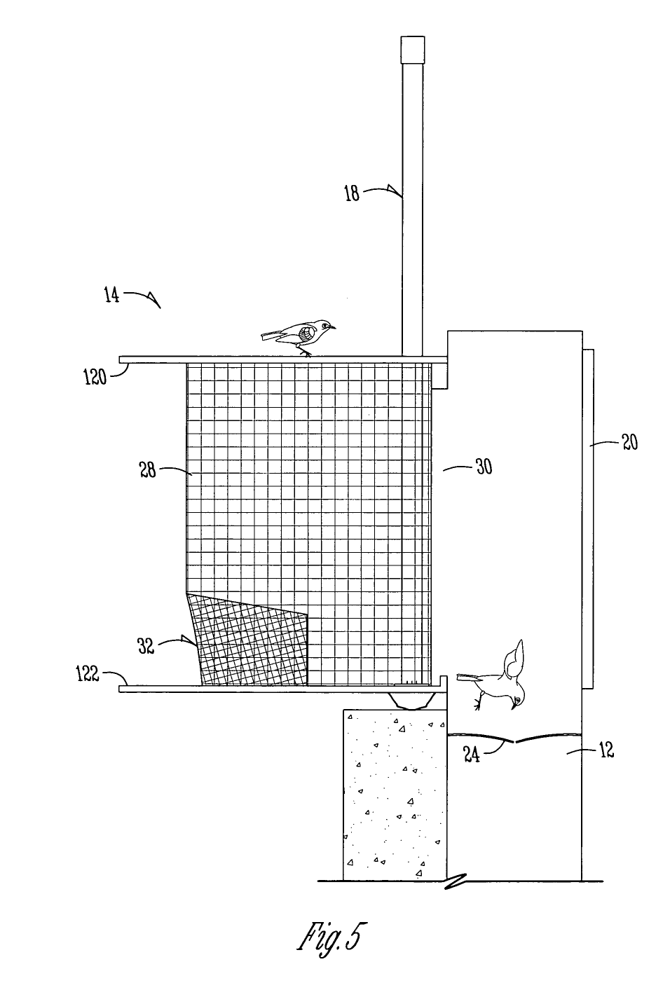

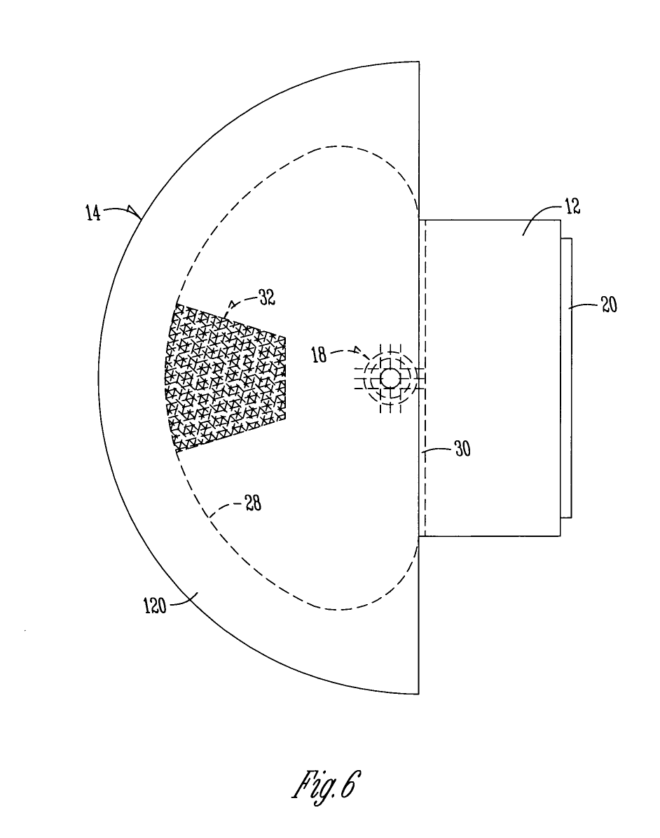

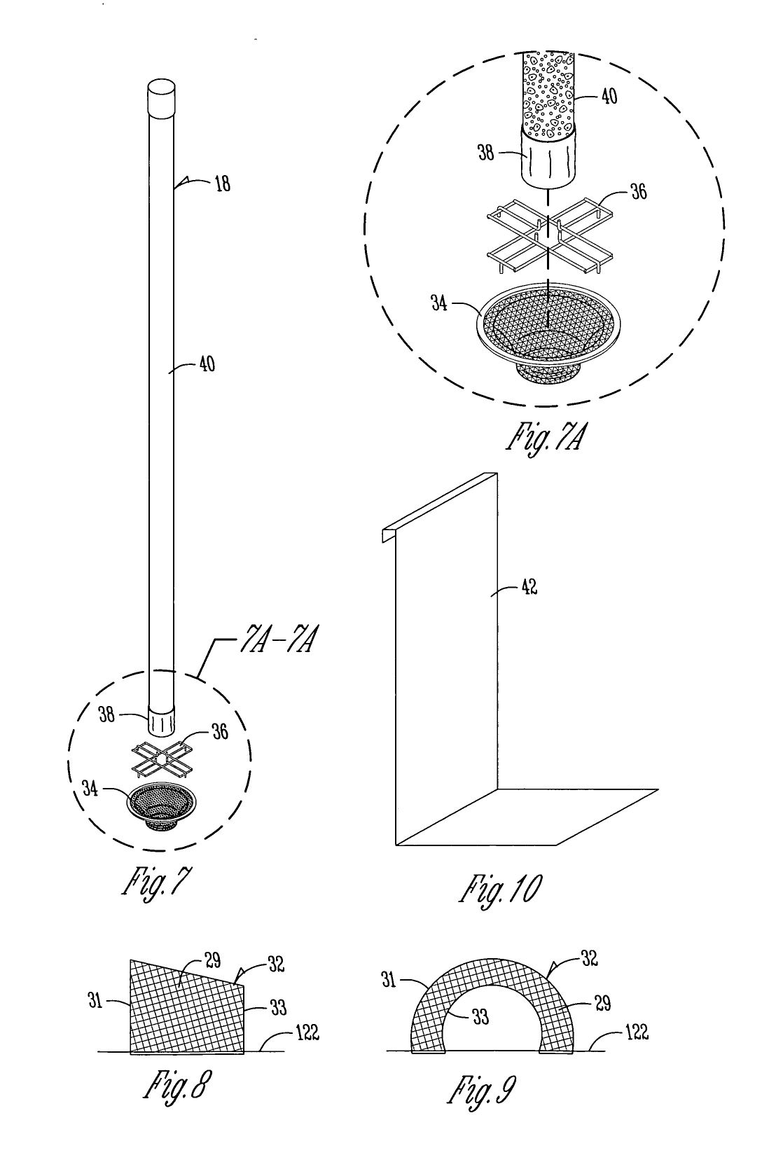

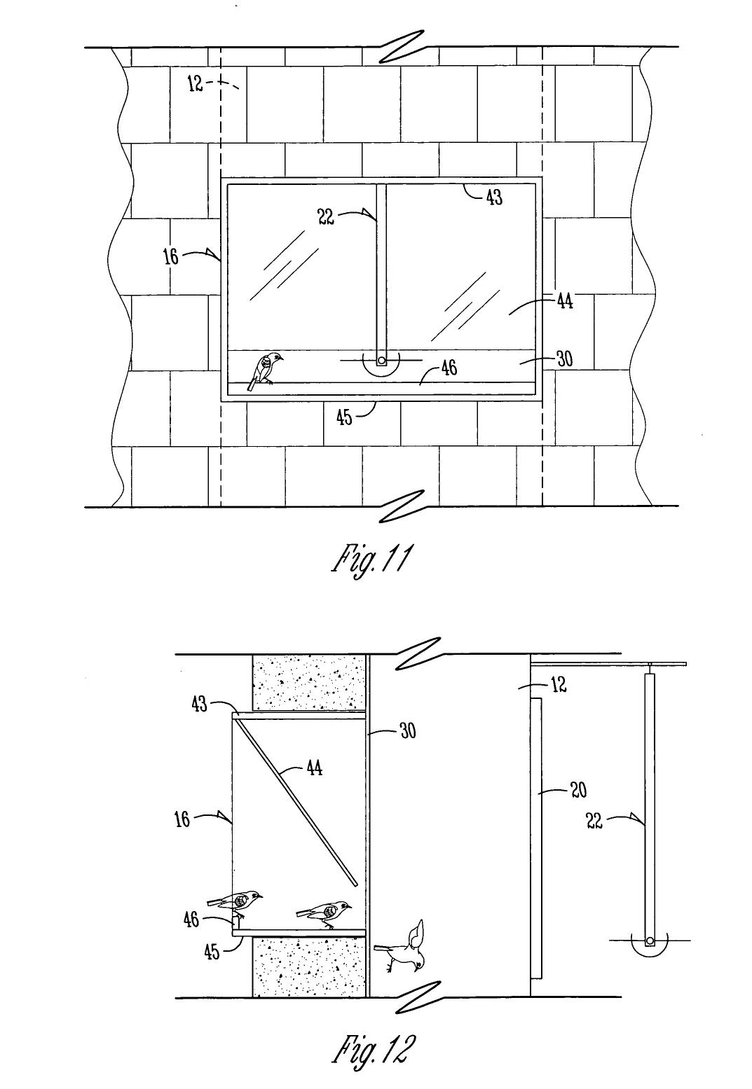

An enlarged view of the inset feeder assembly 18 is shown in FIGS. 7 and 7A. The benefit of the inset feeder assembly 18 is that the feed tube 40 can be inserted through a hole in the top 120 of the rooftop funnel assembly 14 while it is filled with grain or other bird food type substance without spilling the grain, so that the grain is not wasted. The feed tube 40 can be taken in and out of the rooftop funnel assembly 14 and replaced with a full feed tube 40 as needed.

In this embodiment of the inset feeder assembly 18, a puncturable cap 38 is placed around the opening in the bottom of the feed tube 40. It is preferred that the puncturable cap 38 be something such as aluminum foil tape which can be easily punctured and torn away once the feed tube 40 is inserted through a hole in the top 120 of the rooftop funnel assembly 14 and placed over prongs, pins or other devices which stick up on the grate 36. The feeder cup 34 is preferred to be placed inset in a hole or depression in the bottom 122 of the rooftop feeder assembly. Placed over the top of the feeder cup 34 is the grate 36. The preferred feeder cup 34 is a wire mesh cup with a mesh with small enough openings that grain used for attracting the birds does not fall through the mesh. However, moisture can fall through the cup 34 and not spoil the feed. The grate 36 is designed to overlay over the top of the feeder cup 34. This embodiment of the grate 36 is also designed to removeably mount in holes in the bottom 122 of the rooftop funnel assembly 14. Additionally, prongs stick up from the grate 36 which puncture and tear the puncturable cap 38 once the feed tube 40 is positioned over the grate 36 and pushed down over the prongs of the grate 36. Then the operator can rotate or twist the feed tube 40 back and forth so that the prongs which stick up from the grate 36 tear away the puncturable cap 38 and allow the grain which is in the feed tube 40 to fall into the feed cup 34. Being designed this way, the inset feeder assembly 18 can be changed when needed and a full feed tube 40 can be inserted into the rooftop funnel assembly 14 without spilling and wasting the feed.

FIGS. 8 and 9 show one embodiment of the removeable funnel assembly 32. This embodiment of the removeable funnel assembly 32 is built with a wire frame creating a large arch 31 and a small arch 33. A plastic, wire, or fiber mesh 29 covers the wire frame of the removeable funnel assembly 32. The funnel assembly 32 is designed also so that it is insertable and removeable in the bottom 122 of the rooftop funnel assembly 14. The removeable funnel assembly 32 can maintain place on the bottom 122 of the rooftop funnel assembly 14 by a friction fit of the wire frame fitting into grooves, holes or slots in the bottom 122. Additionally, the removable funnel assembly 32 can stay in place on the bottom 122 by screws or other types of fastening systems.

The large arch 31 is designed so as to fit in an opening and match with an opening in the screen 28 of the rooftop feeder assembly 14. Once the funnel assembly 32 is inserted into the bottom 122 of the rooftop feeder assembly 14, the large arch 31 fits an opening in the screen 28 so as to close off any exit for a bird between the funnel assembly 32 and the screen 28. The small arch 33 is preferred to be smaller than the large arch 31 so that as a bird enters the funnel assembly 32, it has to duck down to get through the funnel assembly 32 to get to the inset feeder assembly 18.

Because this system uses a removable funnel assembly 32, the funnel assembly 32 can be taken out to leave an opening in the screen 28 of the rooftop funnel assembly 14. With the funnel assembly 32 removed, a bird can freely travel in and out of the rooftop funnel assembly 14. This aids in training the birds to not fear the rooftop funnel assembly 14. Then, after a time, the funnel assembly 32 can be inserted into the rooftop funnel assembly 14 for trapping the birds. Once the funnel assembly 32 is inserted, a bird can then enter the rooftop funnel assembly 14 through the funnel assembly 32. However, once a bird is walked through the funnel assembly to get to the food in the inset feeder assembly 18 the birds cannot seem to find the way back out through the funnel assembly 32. Therefore, the bird is trapped within the rooftop funnel assembly 14. As discussed above, birds like to travel around the circumference of the screen 28 and that always leads them to the opening 30 in the shaft 12.

FIG. 10 shows a conversion plate 42. The conversion plate 42 can be inserted through a removeable top on the shaft 12 and hung down over the side of the shaft 12. This allows the conversion plate 42 to both cover the window 20 in the shaft 12 and provide a base plate in the shaft 12 so that there is a solid floor continuing from the bottom 122 of the rooftop funnel assembly 14 into the shaft 12. The conversion plate 42 can be inserted and removed as needed. The use of the conversion plate 42 can be used in conjunction with removing the removeable funnel assembly 32 to help train birds to not fear the bird trapping assembly 10. In other words, with the funnel 32 removed and the conversion plate 42 inserted, a bird can travel in and out of both the rooftop funnel assembly 14 and the shaft 12 without being trapped in the bird trapping assembly 10. Thus, when a user is ready to start trapping birds, they can insert the funnel assembly 32 and remove the conversion plate 42 to begin trapping. With the conversion plate 42 in place a bird cannot fall through the shaft 12 and into the holding pen assembly 26. It is preferred that the conversion plate 42 be constructed of sheet metal however, any rigid material can be used.

FIGS. 11 and 12 show one embodiment of a through wall funnel assembly 16. FIG. 11 shows a view looking from inside a building toward the funnel assembly 16. FIG. 12 gives a sectional side view of the funnel assembly 16. The through wall funnel assembly 16 is configured to mount through an opening in an existing building wall and attach to the shaft 12 in an opening in the shaft 30, allowing a bird to travel past the through wall funnel assembly 16 and into the shaft 12. The through wall funnel assembly 16 is designed so that light can travel through the window 20 in the shaft 12 and can also travel through the angle wall 44. This way the light can be seen from inside the building. The birds inside the building will be attracted to the light and thus, the funnel assembly 16. In addition, the birds will be attracted to a hanging feeder assembly 22 which hangs just outside of the window 20. Birds inside the building will see other birds feeding at the hanging feeder assembly 22. This also attracts birds toward the funnel assembly 16.

The through wall funnel assembly 16 is preferred to be created with a top 43, a bottom 45, and an angle wall 44. It is preferred that the angle wall 44 be constructed with glass, Plexiglas, lexan, screen or other transparent material. It is preferred that the angle wall 44 be mounted inside the through wall funnel assembly 16 such that the top portion of the through wall 44 is adjacent to or nearly adjacent to the outer part of the top relative to the shaft 12 and continue downward and inward, leaving a gap at the bottom between the angle wall 44 and the bottom 45. The bottom portion of the angle wall 44 should be located near the opening 30 in the shaft 12 so that as a bird enters the through wall funnel assembly 16 and passes under the angle wall 44 and enters into the shaft area, the bird cannot return to land on the bottom 45. Thus, a bird must fall through the shaft 12 and into the holding pen assembly 26. Additionally, a lip 46 is preferred to be installed on the outward edge of the bottom 45. This gives birds a place to land on the through wall funnel assembly 16. Additionally, bird feed can be placed along the bottom 45 to attract birds to the funnel assembly.

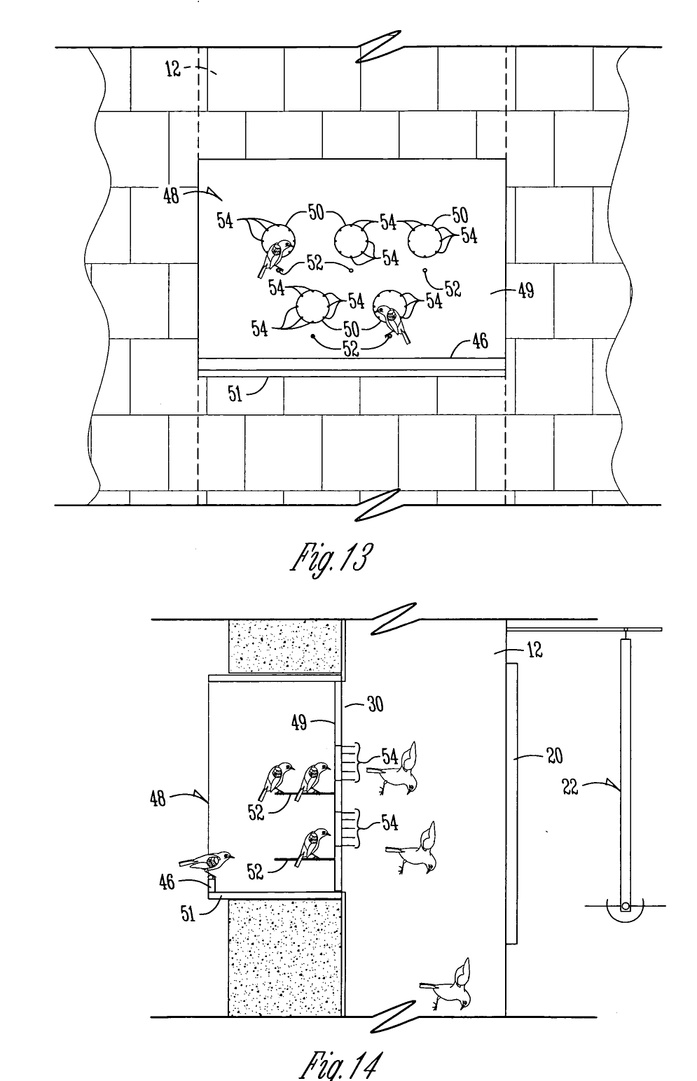

FIGS. 13 and 14 show an alternate through wall funnel assembly 48. FIG. 13 is a view from inside a building toward an opening or window in an existing wall of the building outward toward the bird trapping assembly 10. FIG. 14 is a sectional side view of the alternate through wall funnel assembly 48. This alternate through wall funnel assembly 48 is constructed with a back panel 49 which extends upward from a bottom 51. It is preferred that the back panel 49 is placed towards the opening in the shaft 30 so that once a bird passes through the back panel there is not room for a bird to land on the bottom 51 and must travel downward through the shaft 12 to the holding pen assembly 26. Once again, it is preferred that the alternate through wall funnel assembly 48 have a lip 46 located on the front portion of the bottom 51 for the birds to land on. The bottom 51 can be scattered with bird feed to attract birds to the funnel assembly 48.

It is preferred that this alternate through wall funnel assembly 48 be constructed with one or more bird entrance holes 50. This embodiment of the alternate through wall funnel assembly 48 has landing pins 52 located underneath the bird entrance holes. The landing pins 52 give birds a place for landing before traveling through the bird entrance holes 50. Here again, daylight that travels through the window 20 can be seen through the bird entrance holes 50 from inside of the building. This attracts the birds towards the alternate through wall funnel assembly 48. Once the birds peer through the bird entrance holes 50 they can see through the window 20 on the back side of the shaft 12 and see the hanging feeder assembly. The birds may be attracted to other birds which are feeding at the hanging feeder assembly 22 and may have even fed at the hanging feeder assembly 22 while they were outside. Thus, the birds will travel through the bird entrance holes 50 and enter the shaft area 12 trying to fly through the window 20 to get to the hanging feeder assembly 22. Again, once the bird enters the shaft they cannot maintain forward flight in the shaft and must travel downward through the shaft 12 to the holding pen assembly 26. To prevent the birds from exiting back through the bird entrance holes 50 once they enter the shaft 12, non-exit pins 54 are located on the back side of the bird entrance holes on the back panel 49.

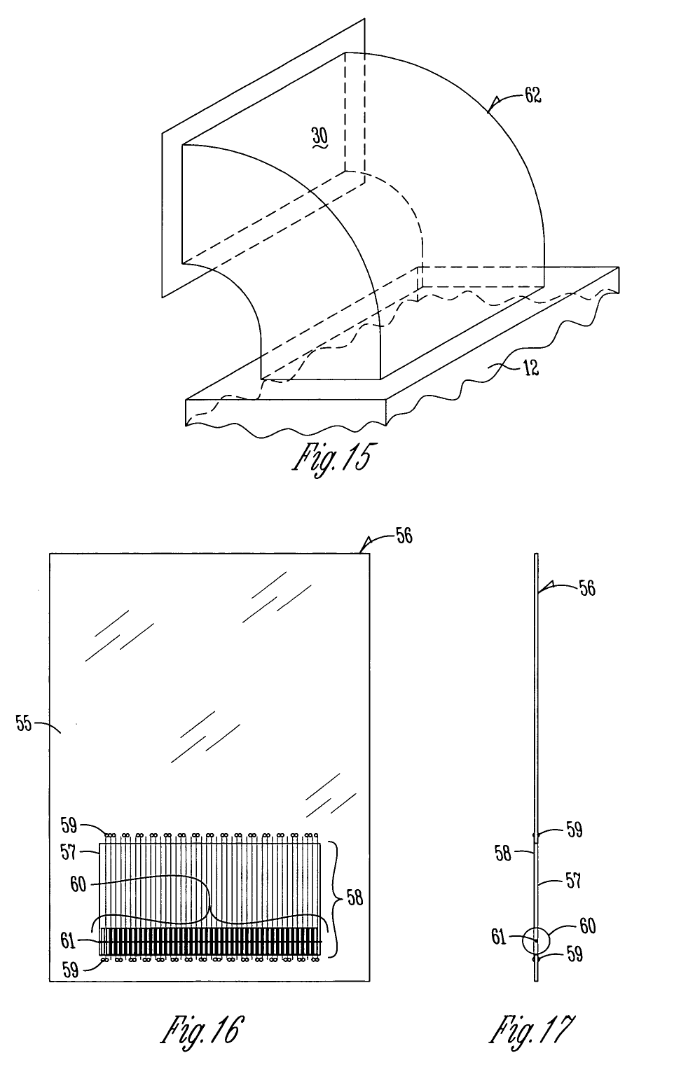

FIG. 15 shows an alternate funnel assembly 62. This alternate funnel assembly 62 is preferred to be constructed of a transparent material such as Plexiglas, lexan, or other similar material. This funnel assembly 62 would simply mount through an opening in an external building wall. Light would shine through the funnel assembly 62 and attract birds inside the building toward the bird trapping assembly 10. Additionally, a hanging feeder assembler 22 could be positioned to hang outside of the alternate funnel assembly 62 to further attract birds to fly into the funnel assembly. This funnel assembly 62 attaches from the opening in the building and curves downward to mate with an opening in the top of the shaft 12. This way, if a bird enters the funnel assembly 62, the only direction the bird can go is to curve around and downward into the shaft 12. Again, once the bird is in the shaft 12 it cannot maintain forward flight and must travel downward through the shaft 12 to the holding pen assembly 26.

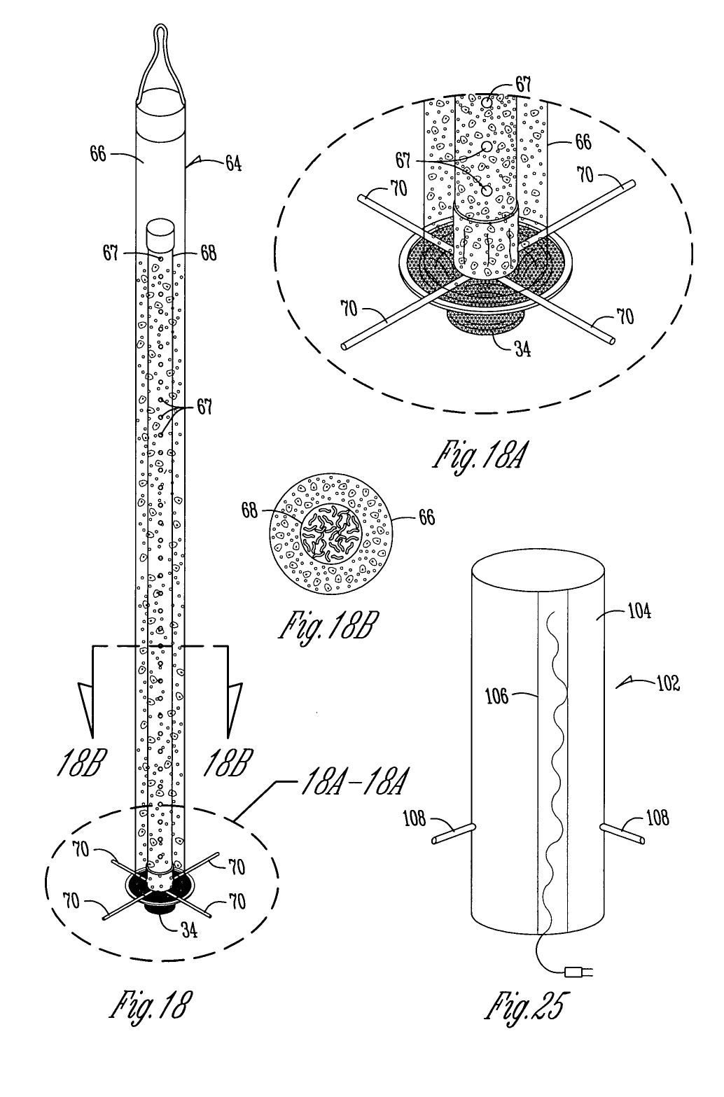

FIGS. 16 and 17 show an alternate window assembly 56. This window can be used in place of the window 20. This window assembly 56 allows both light to travel into the building through the window opening to attract birds, but also allows the sound of birds outside of the window to travel through into the building to attract birds toward the bird trapping assembly 10. As a result, birds which may be feeding at a hanging feeder assembly 22 outside of the shaft 12 can be a further attraction for birds inside the building. Other methods for allowing sound through the window assembly, such as small holes in the window, can be used.

This embodiment of the alternate window assembly 56 is comprised of an alternate window 55 with an opening 57 cut through the window 55. Fishing line, cables, or other similar materials are to be strung between screws 59 across the opening 57 in the window 55. The cables 58 should be placed close enough to one another so that sound can pass through the window assembly 56 and birds cannot pass between the cables 58. To prevent birds from landing or catching on the bottom edge of the opening 57, rollers 60 can be placed on a roller shaft 61 at the bottom of the opening 57. Therefore, if a bird tries to land on the edge created by the opening 57, a bird will contact the rollers 60 which will rotate about a roller shaft 61 and drop the bird into the shaft 12. It is preferred that the cables 58 be strung vertically and tightly between screws 59.

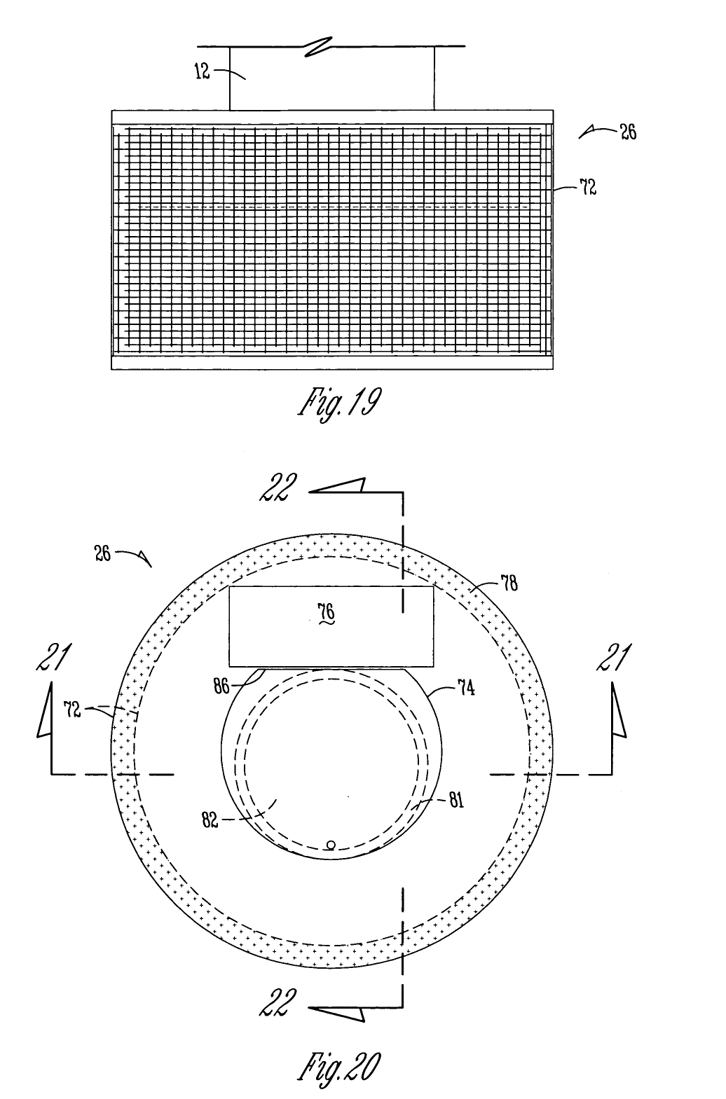

FIGS. 18, 18A and 18B show an alternate feeder assembly 64. This type of feeder assembly can be used with both hanging feeders and inset feeders. This embodiment of a feeder assembly 64 is constructed with a first tube 66 which is preferred to be a transparent material for holding grain or other type of bird food. A second tube 68 which contains worm holes 67 is to be placed inside of the first tube 66. The second tube can contain a different type of food source for attracting birds. For instance, the first tube 66 can contain grains and the second tube can contain live feeder worms. Then, the feeder worms can travel through the worm holes 67 and into the grain mix. Therefore as birds eat feed out of the feeder cup 34, the grain and meal worm mix falls down into the feeder cup 34 and the birds then have access to both the grain and the feeder worm mix. It is commonly known that meal worms are very desirable food for birds. Therefore, this embodiment of feeder can be used to attract even the most stubborn birds towards the bird trapping assembly.

It is preferred that landing shafts 70 extend outward from the alternate feeder assembly 64. Then, a bird can land on the landing shaft 70 to have access to the feed which falls down into the feeder cup 34.

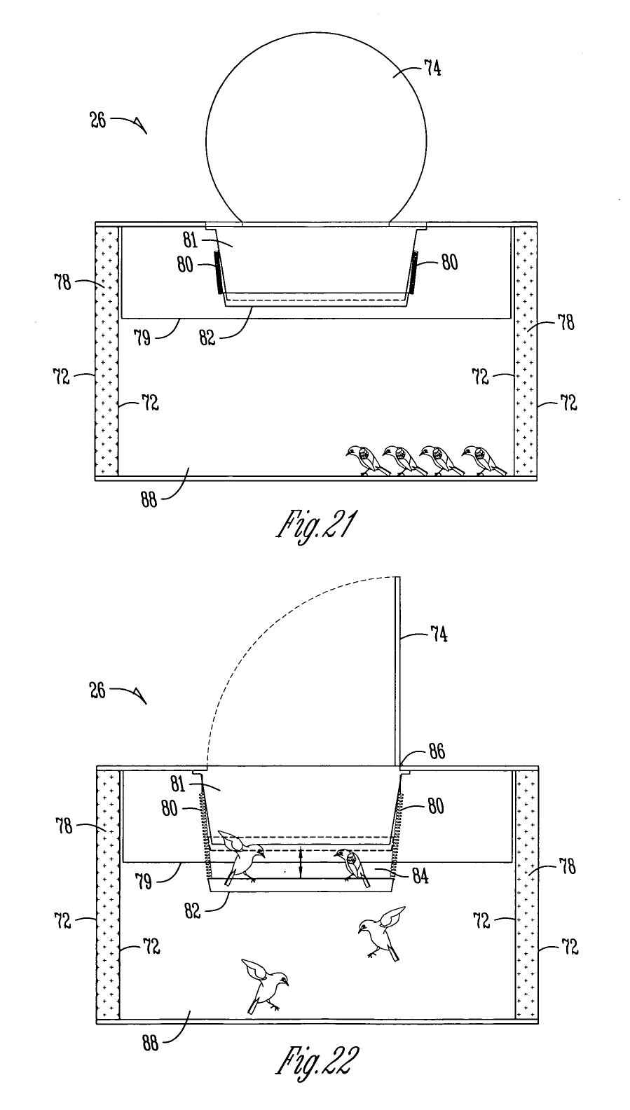

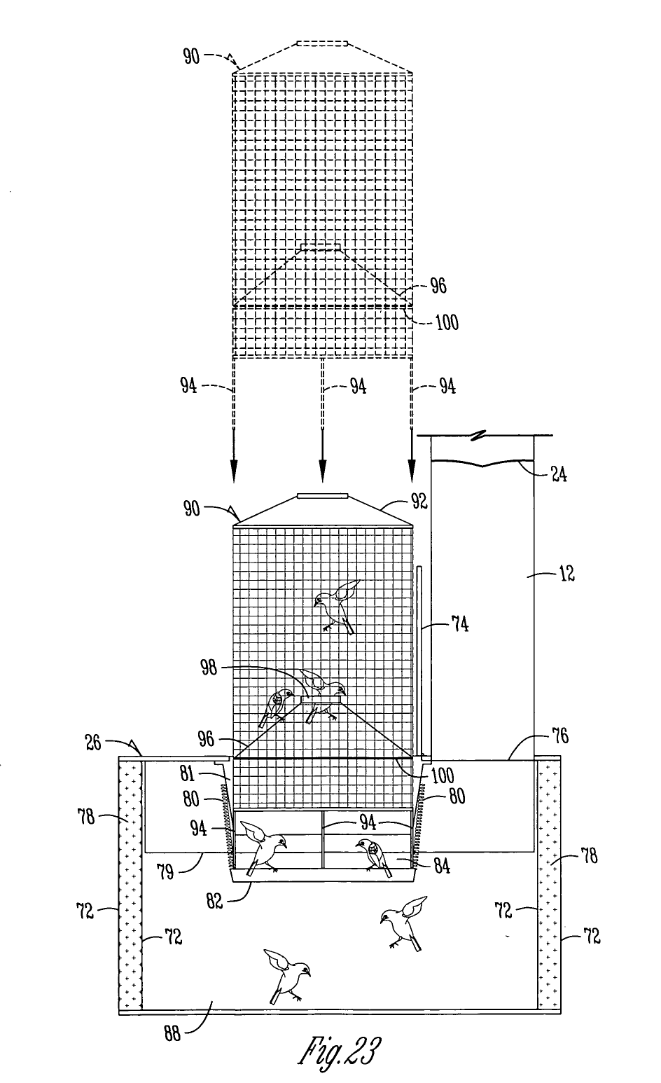

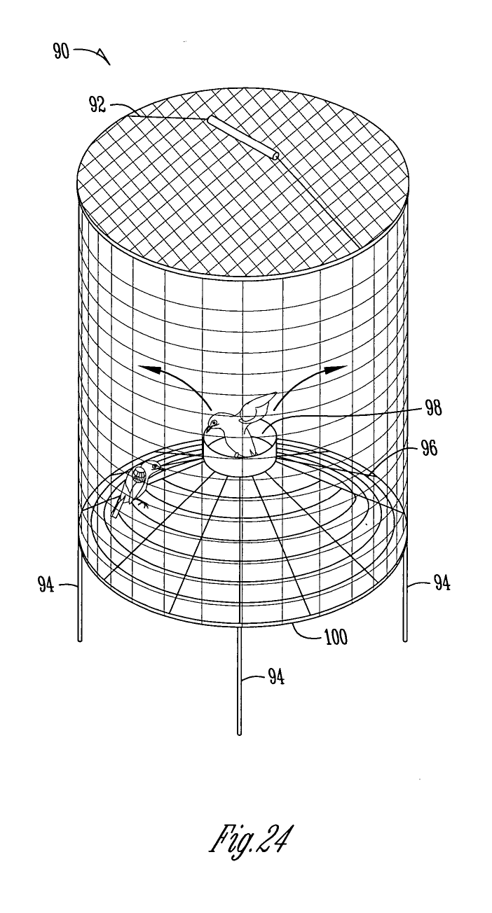

FIGS. 19, 20, 21, 22, and 23 show the holding pen assembly 26. FIG. 19 shows a front view looking towards the holding pen assembly 26. FIG. 20 is a top view looking downward onto the top of the holding pen assembly 26. FIG. 21 is a sectional view of the holding pen assembly 26 as seen from the same view as FIG. 19. FIG. 22 is a sectional view showing the side of the holding pen assembly 26. FIG. 23 shows how the extractor assembly 90 mates with the holding pen assembly 26 to remove birds from the holding pen assembly 26. This embodiment of the holding pen assembly 26 shows the holding pen assembly 26 in a circular shape. However, any shape of holding pen assembly is acceptable. FIGS. 23 and 24 show the extractor assembly 90.

The shaft 12 of the bird trapping assembly 10 is to connectively fit with the opening for shaft area 76 of the holding pen assembly 26. When a bird enters the shaft 12 and falls through the shaft 12, it ends up falling through the opening for shaft 76 area and into the holding area 88 of the holding pen assembly 26. The holding area 88 is to hold the trapped birds until they can be removed.

It is preferred that two layers of wire mesh 72 surround the outside of the holding pen assembly 26. Then, the space in between the two layers of wire mesh 72 should be filled with a breathable, opaque filler 78, such as styrofoam packing peanuts, so that trapped birds can still get air, yet cannot see out of the holding pen assembly 26. Additionally, a sight restrictor 79 is created with sheet metal band around the upper portion of the wire mesh 72 so that as the breathable opaque filler 78 settles, the birds inside the holding area 88 will still not be able to see out of the holding pen assembly 26.

A lid 74 rotates up on the top of the holding pen assembly 26 via a hinge 86 to exposing the docking base 81 and the base 82. The docking base 81 has an open bottom which is covered by the base 82. This prevents birds from escaping or flying through the open bottom in the docking base 81 when the lid 74 is opened.

Springs 80 or other biasing means are attached between the base 82 and the docking base 81. The springs 80 allow the extractor legs 94 to push down the base 82 as the extractor assembly 90 is inserted into the docking base 81. As the extractor legs 94 push down the base 82, the springs 80 are stretched. When the base 82 is in the lower position, an opening 84 is created around the springs 80 between the base 82 and the docking base 81. Thus, birds in the holding pen assembly can fly through the opening 84 onto the base 82. This can be aided by tapping on the holding pen assembly 26 to scare the birds to fly up onto the base 82. This is further aided by the fact that this opening of the base allows daylight to enter through the mesh of the extractor assembly 90. As noted above, birds are attracted to daylight and want to fly towards it.

It is preferred that the extractor assembly 90 be of a longitudinal cylindrical shape, as seen in FIGS. 23 and 24, so as to nest inside of the docking base 81. Additionally, there should not be enough space between the docking base 81 and the extractor assembly 90 to allow birds to go between the docking base 81 and the extractor assembly 90 when the extractor assembly 90 is mated with the docking base 81. It is preferred to have an extractor handle 92 on the extractor assembly 90 for easy carrying and entering and removing the extractor assembly 90 to and from the docking base 81 and the holding pen assembly 26. It is preferred that the extractor assembly 90 be made of a mesh or screen, but other solid or perforated materials can be used.

This embodiment of the extractor assembly 90 has an extractor main funnel 96, an extractor large funnel opening 100 and an extractor small funnel opening 98. It is preferred that the extractor main funnel 96 be of a mesh material and connected all the way around the extractor large funnel opening 100 and connected all the way around the extractor small funnel opening 98. In other words, the extractor main funnel 96 is funnel shaped from the large opening 100 to the small opening 98.

Having the extractor main funnel 96 in this shape allows for birds to fly from either the holding area 88 or the base 82 up through the extractor small funnel opening 98 and into the cage of the extractor assembly 90. Similar to the funnel assembly 32 from the rooftop funnel assembly 14 once a bird enters the extractor assembly 90 the bird cannot find its way back to the center and find the extractor small funnel opening 98 to exit the extractor assembly 90. Therefore, once the birds fly into the extractor assembly 90 and all of the birds are removed from the holding pen assembly 26, then the extractor assembly 90 can be lifted out of the docking base 81 and carried away containing the trapped birds. Additionally, when the extractor assembly 90 is removed from the docking base 81, the base 82 returns to its upper position and birds trapped by the bird trapping assembly 10 after that point again, remain in the holding area 88 of the holding pen assembly 26 until it is emptied at a later time.

FIG. 25 shows a heated waterer assembly 102. The waterer 102 can be used for either attracting birds towards the bird trapping assembly 10 or for maintaining birds in the holding pen assembly 26. The heated waterer assembly 102 is designed to keep water from freezing so that the birds can have a constant water supply source which stays clean. This embodiment of the heated waterer assembly 102 is created in a cylindrical form with a closed top and bottom such that it will hold water. The cylinder has insulated sides 104. Additionally, a heater strip 106 is attached to the heated waterer assembly 102. The heater strip 106 is preferred to plug in to an electrical outlet and keep the water inside the heated waterer assembly 102 from freezing.

One or more drip tubes 108 extend from the heated waterer assembly 102. The drip tubes 108 are hollow in the center and small enough so that water which is contained inside the heated waterer assembly 102 cannot run through the drip tubes 108 in a steady stream. Rather, the drip tubes 108 work in a capillary style thereby having a droplet of water form on the outside end of the drip tube 108. Then, when a bird drinks the water from the end of the drip tube 108 another drip will form on the end and hang there until it is consumed. This is the preferred waterer assembly 102 for use in this invention, however, other embodiments of a waterer can be used.

The invention has been shown and described above with the preferred embodiments, and it is understood that many modifications, substitutions, and additions may be made which are within the intended spirit and scope of the invention. From the foregoing, it can be seen that the present invention accomplishes at least all of its stated objectives.

What is claimed is:

1. A bird trapping device comprising:
a substantially vertical shaft having upper and lower portions;
an opening in the shaft for allowing a bird to enter the shaft;
the shaft precluding a bird entering the shaft from flying such that the bird falls to the lower portion of the shaft for removal.

2. The bird trapping device of claim 1 further comprising a transparent portion in the shaft opposite the opening.

3. The bird trapping device of claim 2 further comprising a bird feeder mounted outside the shaft so as to be visible through the opening and transparent portion.

4. The bird trapping device of claim 1 further comprising a holding pen at the lower portion of the shaft to contain fallen birds.

5. The bird trapping device of claim 4 wherein the holding pen has a door for removing birds from the compartment.

6. The bird trapping device of claim 1 further comprising a bird feeder adjacent the opening.

7. The bird trapping device of claim 1 configured to allow sound from outside to enter the shaft and pass through the opening in the shaft.

8. The bird trapping device of claim 1 further comprising flaps in the shaft allowing bird to pass downwardly but not upwardly.

9. The bird trapping device of claim 1 further comprising a funnel adjacent the opening and a bait station within the funnel to entice birds into the funnel.

10. The bird trapping device of claim 1 wherein the shaft is mounted to the outside of a building wall.

11. The bird trapping device of claim 10 wherein the opening extends through the building wall such that birds inside the building can be trapped and removed.

12. The bird trapping device of claim 10 wherein the opening is adjacent the roof of the building.

13. A food dispensing apparatus comprising:
a first vertical transparent tube;
a removable cover covering an opening in a top of the first tube;
the first tube configured with one or more landing shafts extending radially outward from a bottom of the first tube;
a mesh basket affixed to the bottom of the first tube wherein the first tube is open on the bottom for allowing a first dispensed food to fall into the basket; and
a second vertical tube located concentrically inside of the first tube for dispensing a second food;
the second tube configured with holes in the tube for allowing the second food to mix with the first food for dispensing.

14. A method of removing birds from a building comprising the steps of:
luring birds into a substantially vertical shaft,
preventing the birds from maintaining flight once in the shaft, which causes the bird to fall to a lower portion of the shaft; and
removing the birds from the lower portion of the shaft.

15. The method of claim 14 further comprising funneling the birds toward an opening in the shaft.

16. The method of claim 14 further comprising providing bird feed adjacent an opening in the shaft.

17. The method of claim 14 further comprising holding the fallen birds in a pen at the lower portion of the shaft prior to removal.

18. The method of claim 14 further comprising preventing exiting the shaft by use of a one-way flap in the shaft.

19. The method of claim 14 further comprising deceiving the birds with a transparent portion on the shaft.

20. The method of claim 14 further comprising training the birds to not fear the vertical shaft by baiting the birds to the vertical shaft by allowing the birds for a time to enter and exit the shaft without trapping them.
